(19) United States
(12) Patent Application Publication
(10) Pub. No.: US 2013/0200039 A1
(43) Pub. Date: Aug. 8, 2013

(54) AQUEOUS POLISHING COMPOSITIONS CONTAINING N-SUBSTITUTED DIAZENIUM DIOXIDES AND/OR N'-HYDROXY-DIAZENIUM OXIDE SALTS

(71) Applicants: Bastian Noller, Lorsch (DE); Diana Franz, Schifferstadt (DE); Yuzhuo Li, Heidelberg (DE); Sheik Ansar Usman Ibrahim, Potsdam, NY (US); Harvey Wayne Pinder, Chicago, IL (US); Shyam Sundar Venkataraman, Zhongli City (TW)

(72) Inventors: Bastian Noller, Lorsch (DE); Diana Franz, Schifferstadt (DE); Yuzhuo Li, Heidelberg (DE); Sheik Ansar Usman Ibrahim, Potsdam, NY (US); Harvey Wayne Pinder, Chicago, IL (US); Shyam Sundar Venkataraman, Zhongli City (TW)

(73) Assignee: BASF SE, Ludwigshafen (DE)

(21) Appl. No.: 13/821,759

(22) PCT Filed: Sep. 6, 2011
(86) PCT No.: PCT/IB2011/053891

§ 371 Date: Apr. 25, 2013

Related U.S. Application Data
(60) Provisional application No. 61/380,722, filed on Sep. 8, 2010.

(51) Int. Cl. C09K 13/00

(52) U.S. Cl. CPC C09K 13/00
USPC 216/13; 252/79.1; 216/38; 216/24

(57) ABSTRACT

An aqueous polishing composition comprising (A) at least one water-soluble or water-dispersible compound selected from the group consisting of N-substituted diazenium dioxides and N′-hydroxy-diazenium oxide salts; and (B) at least one type of abrasive particles; the use of the compounds (A) for manufacturing electrical, mechanical and optical devices and a process for polishing substrate materials for electrical, mechanical and optical devices making use of the aqueous polishing composition.

### FIELD OF THE INVENTION

The present invention is directed to novel aqueous polishing compositions, in particular chemical mechanical polishing (CMP) compositions, containing N-substituted diazenium dioxides and/or N′-hydroxy-diazenium oxide salts.

Moreover, the present invention is directed to the novel use of N-substituted diazenium dioxides and/or N′-hydroxy-diazenium oxide salts for manufacturing electrical and optical devices.

Furthermore, the present invention is directed to a novel process for polishing substrate materials for manufacturing electrical, mechanical and optical devices.

### CITED DOCUMENTS

The documents cited in the present application are incorporated by reference in their entirety.

### BACKGROUND OF THE INVENTION

Chemical mechanical planarization or polishing (CMP) is the primary process to achieve local and global planarity of integrated circuits (ICs) devices. The technique typically applies CMP compositions or slurries containing abrasives and other additives as an active chemistry between a rotating substrate surface and a polishing pad under an applied load. Thus, the CMP process couples a physical process such as abrasion with a chemical process such as oxidation or chelation. It is not desirable for the removal or polishing of substrate materials to be comprised of purely physical or purely chemical action, but rather the synergistic combination of both in order to achieve a fast uniform removal.

This way, the substrate material is removed until the desired planarity is achieved or a barrier sublayer or stopping layer is exposed. Ultimately, a planar, defect-free surface is obtained which enables proper multilayer IC device fabrication by subsequent photolithography, patterning, etching and thin-film processing.

Shallow trench isolation (STI) is a specific CMP application which generally requires the selective removal of silicon dioxide to silicon nitride on a patterned wafer substrate. In this case, etched trenches are overfilled with a dielectric material, e.g., silicon dioxide, which is polished using the silicon nitride barrier film as the stopping layer. The CMP process ends with clearing the silicon dioxide from the barrier film while minimizing the removal of exposed silicon nitride and trench silicon oxide.

This requires CMP slurries capable of achieving a high relative ratio of silicon dioxide material removal to silicon nitride removal which ratio is also referred to in the art as oxide-to-nitride selectivity.

Ceria-based CMP slurries have received considerable attention in STI applications because of their ability to achieve a comparatively high oxide-to-nitride selectivity due to the high chemical affinity of ceria to silicon dioxide which is also referred to in the art as the chemical tooth action of ceria.

Nevertheless, the oxide-to-nitride selectivity of ceria-based CMP series must be improved by additives which “tailor” the selectivity.

Thus, P. W. Carter et al. disclose in Electrochemical and Solid-State Letters, 8 (8) G218-G221 (2005), Interfacial Reactivity between Ceria and Silicon Dioxide and Silicon Nitride Surfaces, Organic Additive Effects, the influence of glutamic acid, picolinic acid, 4-hydroxybenzoic acid, imidazole, acetic acid, formic acid, 3-hydroxypicolinic acid, anthranilic acid, pyrrole carboxylic acid, cyclohexane carboxylic acid, piperazine, pyridine, 2-phenylacetic acid, benzoic acid, 3-aminophenol, succinic acid, betain, glycine, proline, benzenesulfonic acid, morpholine, salicylic acid, terephthalic acid, malic acid, isopropanol, citric acid and oxalic acid on the oxide-to-nitride selectivity.

Y. N. Prasad et al. disclose in Electrochemical and Solid-State Letters, 9 (12) G337-G339 (2006), Role of Amino-Acid Absorption on Silica and Silicon Nitride Surfaces during STI CMP, the influence of proline and arginine.

Hyun-Goo Kang et al. disclose in Journal of Material Research, volume 22, No. 3, 2007, pages 777 to 787, the effects of abrasive particles size and molecular weight of poly(acrylic acid) in ceria slurry on removal selectivity of SiO₂/Si₃N₄ films in shallow trench isolation chemical mechanical planarization.

S. Kim et al. disclose in Journal of Colloid and Interface Science, 319 (2008), pages 48 to 52, the absorption behavior of anionic polyelectrolyte for chemical mechanical polishing (CMP).

S. V. Babu et al., Electrochemical and Solid-State Letters, 7 (12) G327-G330 (2004), Slurry Additive Effects on the Suppression of Silicon Nitride Removal during CMP, investigated the influence of arginine, lysine, proline, N-methylglycine, alanine, glycine, picolinic acid, N,N-dimethylglycine, 3-aminobutyric acid and isonicotinic acid.

Jae-Dong Lee et al. disclose in Journal of the Electrochemical Society, 149 (8) G477-G481, 2002, Effects of Nonionic Surfactants on Oxide-To-Polysilicon Selectivity during Chemical Mechanical Polishing, the influence of surfactants such as polyethylene oxide (PEO) and ethyleneoxide-propyleneoxide-ethyleneoxide triblock copolymers on the selectivity. However, the oxide-to-nitride selectivity is not addressed.

The U.S. Pat. No. 5,738,800, U.S. Pat. No. 6,042,741, U.S. Pat. No. 6,132,637 and U.S. Pat. No. 6,218,305 B disclose a ceria-based CMP slurry containing complexing agents such as malic acid, tartaric acid, gluconic acid, citric acid, ortho di- and polyhydroxybenzoic acids, phthalic acid, pyrocathechol, pyrogallol, gallic acid, tannic acid and their salts. Moreover, the ceria-based CMP slurry contains an anionic, cationic, amphoteric or nonionic surfactant The ceria-based CMP slurry is claimed to have a high oxide-to-nitride selectivity.

The U.S. Pat. No. 5,759,917, U.S. Pat. No. 6,689,692 B1 and U.S. Pat. No. 6,984,588 B2 disclose a ceria-based CMP slurry containing a carboxylic acid such as acetic acid, adipic acid, butyric acid, capric acid, caproic acid, caprylic acid, citric acid, glutaric acid, glycolic acid, formic acid, fumaric acid, lactic acid, lauric acid, malic acid, maleic acid, malonic acid, myristic acid, oxalic acid, palmitic acid, phthalic acid, propionic acid, pyruvic acid, stearic acid, succinic acid, tartaric acid, valeric acid, 2-(2-methoxyethoxy)acetic acid, 2-[2-(2-methoxyethoxy)ethoxy]acetic acid, poly(ethylene glycol)bis(carboxymethyl)ether and their derivatives and salts. In addition, the ceria-based CMP slurry contains water-soluble organic and inorganic salts such as nitrates, phosphates and sulfates. The ceria-based CMP slurry is claimed to polish a silicon oxide overfill in preference to a silicon nitride layer.

The U.S. Pat. No. 6,299,659 B1 discloses a ceria-based CMP slurry wherein the abrasive particles have been treated with a silane, titanate, circonate, aluminum and phosphate coupling agent in order to improve the oxide-to-nitride selectivity.

The patent application US 2002/0034875 A1 and the U.S. Pat. No. 6,626,968 B2 disclose a ceria-based CMP slurry containing surfactants, pH adjusting agents such as potassium hydroxide, sulfuric acid, nitric acid, hydrochloric acid or phosphoric acid, and polymers containing a hydrophilic functional group and a hydrophobic functional group such as polyvinyl methyl ether (PVME), polyethylene glycol (PEG), polyoxyethylene 23 lauryl ether (POLE), polypropanoic acid (PPA), polyacrylic acid (PM), and polyether glycol bis ether (PEGBE). However, this ceria-based CMP slurry increases the oxide-to-polysilicon selectivity.

The U.S. Pat. No. 6,436,835 B1 discloses a ceria-based CMP slurry for the shallow 40 trench isolation process comprising water-soluble organic compounds having carboxylic acid or carboxylate or sulfonic acid or sulfamic groups such as polyacrylic acid, polymethacrylic acid, naphthalene sulfonic acid-formalin condensate, malic acid, lactic acid, tartaric acid, gluconic acid, citric acid, succinic acid, adipic acid, fumaric acid, aspartic acid, glutamic acid, glycine 4-aminobutyric acid, 6-aminohexanoic acid, 12-aminolauric acid, arginine, glycylglycine, laurylbenzene sulfonic acid and their ammonium salts. The ceria-based CMP slurry is claimed to have a high oxide-to-nitride selectivity.

The U.S. Pat. No. 6,491,843 B1, U.S. Pat. No. 6,544,892 B2 and U.S. Pat. No. 6,627,107 B2 disclose a ceria-based CMP slurry containing alpha-amino acids such as lysine, alanine, and proline for improving the oxide-to-nitride selectivity.

The U.S. Pat. No. 6,616,514 B1 discloses a ceria-based CMP slurry containing organic polyols having at least 3 hydroxyl groups that are not dissociable in the aqueous medium; or a polymer formed from at least one monomer having at least 3 hydroxyl groups that are not dissociable in the aqueous medium such as mannitol, sorbitol, mannose, xylitol, sorbose, sucrose, and dextrin for improving the oxide-to-nitride selectivity.

The Japanese patent application JP 2005-336400 A discloses a ceria-based CMP slurry comprising a water-soluble condensed phosphate such as pyrophosphate, tripolyphosphate and hexametaphosphoric acid salt, and a water-soluble carbonate or hydrogencarbonate. The ceria-based CMP slurry may furthermore contain a water-soluble organic solvent such as methanol, ethanol, 1-propanol, 2-propanol, 1-butanol, 2-butanol, ethylene glycol, propylene glycol and 1,2,3-propanetriol, ketones such as acetone and methylethylketone, tetrahydrofurane, N,N-dimethylformamide, dimethyl sulfoxide, and 1,4-dioxane.

The U.S. Pat. No. 7,071,105 B2 and the American application US 2006/0144824 A1 disclose a ceria-based CMP slurry containing a polishing additive comprising functional groups having a pKa of 4 to 9. The polishing additive is selected from the group consisting of arylamines, aminoalcohols, aliphatic amines, heterocyclic amines, hydroxamic acids, aminocarboxylic acids, cyclic monocarboxylic acids, unsaturated monocarboxylic acids, substituted phenols, sulfonamides, thiols and salts thereof, in particular, chlorides, bromides, sulfates, sulfonates, trifluoromethyl sulfonates, acetates, trifluoroacetates, picrates, perfluorobutyrates as well as sodium, potassium and ammonium salts.

The arylamines expressly mentioned are aniline, 4-chloroaniline, 3-methoxyaniline, N-methylaniline, 4-methoxyaniline, p-toluidine, anthranilic acid, 3-amino-4-hydroxybenzenesulfonic acid, aminobenzylalcohol, aminobenzylamine, 1-(-aminophenyl)pyrrole, 1-(3-aminophenyl)ethanol, 2-aminophenyl ether, 2,5-bis-(4-aminophenyl)-1,3,4-oxidadiazole, 2-(2-aminophenyl)-1H-1,3,4-triazole, 2-aminophenyl, 3-aminophenyl, 4-aminophenyl, dimethylaminophenol, 2-aminothiolphenol, 3-aminothiolphenol, 4-aminophenyl methyl sulfide, 2-aminobenzenesulfonamide, orthanilic acid, 3-aminobenzene boronic acid, 5-aminoisophthalic acid, sulfacetamide, sulfanilic acid,o- or p-arsanilic acid, and(3R)-3-(4-trifluoromethylphenylamino)pentanoic acid.

The aminoalcohols expressly mentioned are triethanolamine, benzyldiethanolamine, tris(hydroxylmethyl)aminomethane, hydroxylamine, and tetracycline.

The aliphatic amines expressly mentioned are methoxyamine, hydroxylamine, N-methylhydroxylamine, N,O-dimethylhydroxylamine, beta-difluoroethylamine, ethylenediamine, triethylenediamine, diethyl((butylamino)(2-hydroxyphenyl)methyl)phosphonate, iminoethanes, iminobutanes, triallylamine, cyanoamines such as aminoacetonitrile, dimethylaminoacetonitrile, 2-amino-2-cyanopropane, isopropylaminopropionitrile, diethylaminopropionitrile, aminopropionitrile, dicyanodiethylamine), hydrazine, methylhydrazine, tetramethylhydrazine, N,N-dimethylhydrazine, phenylhydrazine, N,N-diethylhydrazine, trimethylhydrazine, ethylhydrazine and salts thereof.

The heterocyclic amines expressly mentioned are imidazole, 1-methylimidazole, 2-methylimidazole, 2-ethylimidazole, 2-hydroxylmethylimidazole, 1-methyl-2-hydroxylmethylimidazole, benzoimidazole, quinoline, isoquinoline, hydroxyquinoline, melamine, pyridine, bipyridine, 2-methylpyridine, 4-methylpyridine, 2-aminopyridine, 3-aminopyridine, 2,3-pyridinedicarboxylic acid, 2,5-pyridinedicarboxylic acid, 2,6-pyridinedicarboxylic acid, 5-butyl-2-pyridinecarboxylic acid, 2-pyridinecarboxylic acid, 3-hydroxy-2-pyridinecarboxylic acid, 4-hydroxy-2-pyridinecarboxylic acid, 3-benzoyl-2-pyridinecarboxylic acid, 6-methyl-2-pyridinecarboxylic acid, 3-methyl-2-pyridinecarboxylic acid, 6-bromo-2-pyridinecarboxylic acid, 6-chloro-2-pyridinecarboxylic acid, 3,6-dichloro-2-pyridinecarboxylic acid, 4-hydrazino-3,5,6-trichloro-2-pyridinecarboxylic acid, 2-quinolinecarboxylic acid, 4-methoxy-2-quinolinecarboxylic acid, 8-hydroxy-2-quinolinecarboxylic acid, 4,8-hydroxy-2-quinolinecarboxylic acid, 7-chloro-4-hydroxy-2-quinolinecarboxylic acid, 5,7-dichloro-4-hydroxy-2-quinolinecarboxylic acid, 5-nitro-2-quinolinecarboxylic acid, 1-isoquinolinecarboxylic acid, 3-isoquinolinecarboxylic acid, acridine, benzoquinoline, benzacridine, clonidine, anabasine, nornicotine, triazolopyridine, pyridoxine, serotonin, histamine, benzodiazepine, aziridine, morpholine, 1,8-diazabicyclo(5,4,0)undecene-7 DABCO, hexamethylenetetramine, piperazine, N-benzoylpiperazine, 1-tosylpiperazine,N-carboxyethylpiperazine,1,2,3-triazole, 1,2,4-triazole, 2-aminothiazole, pyrrole, pyrrole-2-carboxylic acid, 3-pyrroline-2-carboxylic acid, ethylpyrroline, cyclohexylpyrroline, tolylpyrroline, tetrazole, 5-cyclopropyltetrazole, 5-hydroxytetrazole, 5-phenoxytetrazole, 5-phenyltetrazole, fluorouracil, methylthiouracil, 5,5-diphenylhydantoin, 5,5-dimethyl-2,4-oxazolidinedione, phthalimide, succinimide, 3,3-methylphenylglutarimide, 3,3-dimethylsuccinimide, imidazol[2,3-b]thioxazole, hydroxyemidazo[2,3-a]isoindole, 5,5-methylphenylbarbituric acid, 1,5,5-trimethylbarbituric acid, hexobarbital, 5,5-dimethylbarbituric acid, 1,5-dimethyl-5-phenylbarbituric acid and their salts.

The hydroxamic acids specifically mentioned are formohydroxamic acid, acetohydroxamic acid, benzohydroxamic acid, salicylhydroxamic acid, 2-aminobenzohydroxamic acid, 2-chlorobenzohydroxamic acid, 2-fluorobenzohydroxamic acid, 2-nitrobenzohydroxamic acid, 3-nitrobenzohydroxamic acid, 4-aminobenzohydroxamic acid, 4-chlorobenzohydroxamic acid, 4-fluorobenzohydroxamic acid, 4-nitrobenzohydroxamic acid and their salts.

The aminocarboxylic acids expressly mentioned are glutamic acid, beta-hydroxyglutamic acid, aspartic acid, asparagine, azaserine, cysteine, histidine, 3-methylhistidine, cytosine, 7-aminocephalosporanic acid and carnosine.

The cyclic monocarboxylic acids expressly mentioned are naphthalene-2-carboxylic acid, cyclohexane carboxylic acid, cyclohexyl acetic acid, 2-phenyllactic acid, 4-hydroxybenzoic acid, 3-hydroxybenzoic acid, 2-pyridinecarboxylic acid, cis- and trans-, cyclohexane carboxylic acid, benzoic acid eyes and salts thereof.

The unsaturated monocarboxylic acids expressly mentioned are cinnamic acid, acrylic acid, 3-chloroprop-2-enecarboxylic acid, crotonic acid, 4-but-2-enecarboxylic acid, cis- or trans-2-pentanoic acid, 2-methyl-2-pentanoic acid, 2-hexenoic acid and 3-ethyl-2-hexenoic acid and their salts.

The phenols expressly mentioned are nitrophenol, 2,6-dihalo-4-nitrophenols, 2,6-di-C₁₋₁₂-alkyl-4-nitrophenols, 2,4-dinitrophenol, 3,4-dinitrophenol, 2-C₁₋₁₂-alkyl-4,6-dinitrophenols, 2-halo-4,6-dinitrophenols, dinitro-o-cresol, picric acid and salts thereof.

The sulfonamides expressly mentioned are N-chlorotolylsulfonamide, dichlorophenamide mafenide, nimesulide, sulfamethizole, sulfaperin, sulfacetamide, sulfadiazine, sulfadimethoxine, sulfamethazine, sulfapyridine, sulfaquinoxaline and their salts.

The thiols expressly mentioned are hydrogen disulfide, cysteamine, cysteinylcysteine, methyl cysteine, thiophenol, p-chloro thiophenol, o-aminothiolphenol, o-mercaptophenyl acetic acid p-nitrobenzenethiol, 2-mercaptoethanesulfonate, N-dimethylcysteamine, dipropylcysteamine, diethylcysteamine, mercaptoethylmorpholine, methylthioglycolate, mercaptoethylamine, N-trimethylcysteine, glutathione, mercaptoethylpiperidine, diethylaminopropanethiol and their salts.

The polishing additives are believed to increase the oxide-to-nitride selectivity.

The American patent application US 2006/0207188 A1 discloses a ceria-based CMP slurry containing the reaction product of a polymer such as polyacrylic acid or poly(alkyl methacrylate) and a monomer such as acrylamide, methacrylamide, ethyl-methacrylamide, vinylpyridine, or vinylpyrrolidone. The reaction products are believed to increase also the oxide-to-nitride selectivity.

The American patent application US 2006/0216935 A1 discloses a ceria-based CMP slurry comprising protein, lysine and/or arginine and a pyrrolidone compounds such as polyvinylpyrrolidone (PVP), N-octyl-2-pyrrolidone, N-ethyl-2-pyrrolidone, N-hydroxyethyl-2-pyrrolidone, N-cyclohexyl-2-pyrrolidone, N-butyl-2-pyrrolidone, N-hexyl-2-pyrrolidone, N-decyl-2-pyrrolidone, N-octadecyl-2-pyrrolidone, and N-hexadecyl-2-pyrrolidone. The ceria-based CMP slurry can furthermore contain dispersing agents like polyacrylic acid, glycols and polyglycols. Specific examples use proline, polyvinylpyrrolidone or N-octyl-2-pyrrolidone, PPO/PEO blockcopolymers, and glutaraldehyde. The ceria-based CMP slurry is believed to not aggressively remove trench silicon dioxide thereby allowing for extended polishing beyond the endpoint without substantially increasing the minimum step height.

The American patent application US 2007/0077865 A1 discloses a ceria-based CMP slurry containing polyethyleneoxides/polypropyleneoxide copolymers preferably from the Pluronic™ family is sold by BASF. The ceria-based CMP slurry can furthermore contain amino alcohols such as 2-dimethylamino-2-methyl-1-propanol (DMAMP), 2-amino-2-ethyl-1-propanol (AMP), 2-(2-aminoethylamino)ethanol, 2-(isopropylamino)ethanol, 2-(methylamino)ethanol, 2-(diethylamino)ethanol, 2-(2-dimethylamino)ethoxy)ethanol, 1,1-[[3-(dimethylamino)propyl]imino]-bis-2-propanol, 2-(2-butylamino)ethanol, 2-(tert-butylamino)ethanol, 2-(diisopropylamino)ethanol, and N-(3-aminopropyl)morpholine. The ceria-based CMP slurry may furthermore contain quaternary ammonium compounds like tetramethylammonium hydroxide, film forming agents such as alkyl amines, alkanolamines, hydroxyl amines, phosphate esters, sodium lauryl sulfate, fatty acids, polyacrylates, polymethacrylates, polyvinylphosphonates, polymalates, polystyrene sulfonate, polyvinyl sulfate, benzotriazole, triazole, and benzoimidazole, and complexing agents such as acetylacetone, acetates, glycolates, lactates, gluconates, gallic acid, oxalates, phthalates, citrates, succinates, tartates, malates, ethylenediaminetetraacetic acid, ethylene glycol, pyrocatechol, pyrogallol, tannic acid, phosphonium salts and phosphonic acids. The ceria-based CMP slurry is believed to provide good selectivity of silicon oxide and/or silicon nitride relative to polysilicon.

The American patent application US 2007/0175104 A1 discloses a ceria-based CMP slurry comprising a polysilicon polishing inhibitor which is selected from water-soluble polymers having a N-monosubstituted or N,N-di-substituted skeleton substituted by any members selected from the group consisting of acrylamide, methacrylamide and alpha-substituted derivatives thereof; polyethylene glycols; polyvinylpyrrolidones; alkyloxylated linear aliphatic alcohols and ethyleneoxide adducts of acetylene-based diols. The ceria-based CMP slurry may contain additional water-soluble polymers such as polysaccharides like alginic acid, pectin acid, carboxymethylcellulose, agar, curdlan, and pullulan; polycarboxylic acids such as polyaspartic acid, polyglutamic acid, polylysine, polymalic acid, polymethacrylic acid, polyimide acid, polymaleic acid, polyitaconic acid, polyfumaric acid, poly(p-styrene carboxylic acid), polyacrylic acid, polyacrylamide, amino polyacrylamide, polyglyoxalic acid and their salts; and vinyl polymers such as polyvinyl alcohol, and polyacrolein. The ceria-based CMP slurry is said to have a high silicon oxide over polysilicon selectivity.

The American patent application US 2007/0191244 A1 discloses a ceria-based CMP slurry containing a compound having a weight-average molecular weight of 30 to 500 and containing hydroxyl groups and a carboxyl group or both such as citrates, malates, gluconates, tartrates, 2-hydroxyisobutyrates, adipates, octanoates, succinates, EDTA-containing compounds, glutarates, methylenesuccinates, mannose, glycero-galacto-heptose, erythro-manno-octose, arabino-galacto-nonose, and glutamine. The ceria-based CMP slurry may furthermore contain linear polymer acids or graft type polymer acids having alkoxypolyalkylene glycol side chains. The ceria-based CMP slurry is said to achieve an improved global planarity of the polished wafers.

The American patent application US 2007/0218811 A1 discloses a ceria-based CMP slurry having a pH of 4 to 7.5 and containing a dispersing agent, a polycarboxylic acid, and 100 to 1000 ppm of a strong acid having a pKa of its first dissociable acidic group at 3.2 or less. By way of examples, polymers of acrylic acid and methacrylic acid are mentioned as anionic dispersing agents, polyoxyethylene derivatives are mentioned as nonionic dispersing agents, and polyvinylpyrrolidone is mentioned as a cationic dispersing agent. Specifically mentioned strong acids are sulfuric acid, HCl, nitric acid, phosphoric acid, oxalic acid, maleic acid, picric acid, sulfurous acid, thiosulfurous acid, amidosulfuric acid, chloric acid, perchloric acid, chlorous acid, hydroiodic acid, periodic acid, iodic acid, hydrobromic acid, perbromic acid, chromic acid, nitrous acid, diphosphonic acid, tripolyphosphoric acid, phosphinic acid, picolinic acid, phosphonic acid, isonicotinic acid, nicotinic acid, trichloroacetic acid, dichloroacetic acid, chloroacetic acid, cyanoacetic acid, oxaloacetic acid, nitroacetic acid, bromoacetic acid, fluoroacetic acid, phenoxyacetic acid, o-bromobenzoic acid, o-nitrobenzoic acid, o-chlorobenzoic acid, p-aminobenzoic acid, anthranilic acid, phthalic acid, fumaric acid, malonic acid, tartaric acid, citric acid, o-chloroaniline, 2,2′-bipyridine, 4,4′-bipyridine, 2,6-pyridinedicarboxylic acid, pyruvic acid, polystyrene sulfonic acid, polysulfonic acid, glutamic acid, salicylic acid, aspartic acid, 2-aminoethylphosphonic acid, lysine, arginine, isoleucine, sarcosine, ornithine, guanosine, citrulline, tyrosine, valine, hypoxanthine, methionine, lysine, and leucine. The ceria-based CMP slurry is to cause an efficient high-speed operation, an easier process management and a smaller fluctuation in film thickness due to difference in pattern density.

The fabrication of electrical devices, in particular, semiconductor integrated circuits (ICs); requires high precision methods which involve inter alia high selectivity CMP.

Although the prior art ceria-based CMP slurries may have a satisfactory oxide-to-nitride selectivity and may yield polished wafers having a good global and local planarity as exemplified by the within-wafer nonuniformity (WIWNU) and the wafer-to-wafer nonuniformity (WTWNU), the ever decreasing dimensions of the IC architectures, in particular ICs with LSI (large-scale integration) or VLSI (very-large-scale integration), necessitate the constant improvement of the ceria-based CMP slurries in order to meet the ever increasing technical and economical demands of the manufacturers of integrated circuit devices.

However, this pressing need to constantly improve the prior art ceria-based CMP slurries does not only apply to the field of integrated circuit devices, but the polishing and planarization efficacy has also to be improved in the fields of manufacturing other electrical devices such as liquid crystal panels, organic electroluminescent panels, printed circuit boards, micro machines, DNA chips, micro plants, photovoltaic cells, and magnetic heads; as well as high precision mechanical devices and optical devices, in particular, optical glasses such as photo-masks, lenses and prisms, inorganic electro-conductive films such as indium tin oxide (ITO), optical integrated circuits, optical switching elements, optical waveguides, optical monocrystals such as the end faces of optical fibers and scintillators, solid laser monocrystals, sapphire substrates for blue laser LEDs, semiconductor monocrystals, and glass substrates for magnetic disks. The manufacturing of such electrical and optical devices requires high precision CMP process steps.

Likewise, the manufacturing of high precision mechanical devices also requires high precision CMP process steps.

One of the major drawbacks of the prior art ceria-based CMP slurries is that they are prone to attack by microorganisms and fungi. Therefore, they become unstable upon storage due to bacterial and fungal growth, which growth has a deleterious effect on the particle size distribution of the abrasive ceria particles which, in turn, leads to an irreversible agglomeration and sedimentation of the ceria particles.

One has tried to ameliorate this severe problem by adding biocides. However, the prior art biocides also tend to destabilize the particle size distribution of the abrasives in an unpredictable way.

N-substituted diazenium dioxides and N′-hydroxy-diazenium oxide salts, methods of their preparation and their use as wood preservatives as well as bactericides and fungicides suitable as disinfectants and for the finishing of textiles, plastics, buildings materials or paint systems are known from the German patent application DE 38 35 370 A1, the U.S. Pat. No. 5,393,874, the European patent application EP 0 588 249 A1, and the international patent application WO 90/01033. No mention whatsoever is made that N-substituted diazenium dioxides and N′-hydroxy-diazenium oxide salts could be used in polishing compositions, in particular in ceria-based CMP slurries.

### OBJECTS OF THE INVENTION

Therefore, it is an object of the present invention to provide a novel aqueous polishing composition, in particular a novel chemical mechanical polishing (CMP) composition, especially a novel ceria-based CMP slurry, which no longer exhibits the disadvantages and drawbacks of the prior art polishing compositions.

In particular, the novel aqueous polishing composition, in particular the novel chemical mechanical polishing (CMP) composition, especially the novel ceria-based CMP slurry, should exhibit a significantly improved oxide-to-nitride selectivity and yield polished wafers having an excellent global and local planarity as exemplified by the within-wafer nonuniformity (WIWNU) and the wafer-to-wafer nonuniformity (WTWNU). Therefore, they should be excellently suited for manufacturing IC architectures, in particular ICs with LSI (large-scale integration) or VLSI (very-large-scale integration), having structures with dimensions below 50 nm.

Moreover, the novel aqueous polishing composition, in particular the novel chemical mechanical polishing (CMP) composition and especially the novel ceria-based CMP slurry should not only be exceptionally useful in the field of integrated circuit devices, but should also be most efficiently and advantageously useful in the fields of manufacturing other electrical devices such as liquid crystal panels, organic electroluminescent panels, printed circuit boards, micro machines, DNA chips, micro plants and magnetic heads; as well as high precision mechanical devices and optical devices, in particular, optical glasses such as photo-masks, lenses and prisms, inorganic electro-conductive films such as indium tin oxide (ITO), optical integrated circuits, optical switching elements, optical waveguides, optical monocrystals such as the end faces of optical fibers and scintillators, solid laser monocrystals, sapphire substrates for blue laser LEDs, semiconductor monocrystals, and glass substrates for magnetic disks.

Most particularly, the novel ceria-based CMP slurries should no longer be prone to attack by microorganisms and fungi and, therefore, should no longer exhibit a bacterial and fungal growth during prolonged storage and no destabilization of the particle size distribution of the abrasive ceria particles. Consequently, no irreversible agglomeration and sedimentation of the ceria particles should take place.

It is still another object of the present invention, to provide a novel use for N-substituted diazenium dioxides and N′-hydroxy-diazenium oxide salts.

It is a further object of the present invention to provide a novel process for polishing substrate materials of mechanical, electrical and optical devices.

### SUMMARY OF THE INVENTION

Accordingly, the novel aqueous polishing composition has been found, the said polishing composition comprising
(A) at least one water-soluble or water-dispersible compound selected from the group consisting of N-substituted diazenium dioxides and N′-hydroxy-diazenium oxide salts; and
(B) at least one type of abrasive particles.

The hereinafter, the novel aqueous polishing composition is referred to as the “composition of the invention”.

Moreover, the novel process for polishing substrate materials of mechanical, electrical and optical devices has been found, which process makes use of the composition of the invention.

Hereinafter, the novel process for polishing substrate materials of mechanical, electrical and optical devices is referred to as the “process of the invention”.

And last but not least, the novel use of N-substituted diazenium dioxides and N′-hydroxy-diazenium oxide salts for manufacturing mechanical, electrical and optical devices has been found, which use is hereinafter referred to as the “use of the invention”.

### Advantages of the Invention

In view of the prior art, it was surprising and could not be expected by the skilled artisan that the objects of the present invention could be solved by the composition of the invention, the process of the invention and the use of the invention.

It was particularly surprising that the composition of the invention exhibited a significantly improved oxide-to-nitride selectivity and yield polished wafers having an excellent global and local planarity as exemplified by the within-wafer nonuniformity (WIWNU) and the wafer-to-wafer nonuniformity (WTWNU). Therefore, they were excellently suited for manufacturing IC architectures, in particular ICs with LSI (large-scale integration) or VLSI (very-large-scale integration), having structures with dimensions below 50 nm.

Moreover, the composition of the invention was not only exceptionally useful in the field of integrated circuit devices, but was also most efficiently and advantageously useful in the fields of manufacturing other electrical devices such as liquid crystal panels, organic electroluminescent panels, printed circuit boards, micro machines, DNA chips, micro plants and magnetic heads; as well as high precision mechanical devices and optical devices, in particular, optical glasses such as photo-masks, lenses and prisms, inorganic electro-conductive films such as indium tin oxide (ITO), optical integrated circuits, optical switching elements, optical waveguides, optical monocrystals such as the end faces of optical fibers and scintillators, solid laser monocrystals, sapphire substrates for blue laser LEDs, semiconductor monocrystals, and glass substrates for magnetic disks.

Most particularly, the composition of the invention was no longer prone to the attack by microorganisms and fungi and, therefore, no longer exhibited a bacterial and fungal growth during prolonged storage and no destabilization of the particle size distribution of the abrasive ceria particles. Consequently, no irreversible agglomeration and sedimentation of the ceria particles took place.

Therefore, the composition of the invention was most particularly useful for the process of the invention. The process of invention could be most advantageously used for polishing, in particular chemically mechanically polishing substrate materials for electrical devices such as liquid crystal panels, organic electroluminescent panels, printed circuit boards, micro machines, DNA chips, micro plants and magnetic heads; as well as substrate materials for high precision mechanical devices and optical devices, in particular, optical glasses such as photo-masks, lenses and prisms, inorganic electro-conductive films such as indium tin oxide (ITO), optical integrated circuits, optical switching elements, optical waveguides, optical monocrystals such as the end faces of optical fibers and scintillators, solid laser monocrystals, sapphire substrates for blue laser LEDs, semiconductor monocrystals, and glass substrates for magnetic disks.

### DETAILED DESCRIPTION OF THE INVENTION

The composition of the invention is an aqueous composition. This means that it contains water, in particular ultrapure water, as the main solvent and dispersing agent. Nevertheless, the composition of the invention may contain at least one water-miscible organic solvents, however, only in minor amounts that do not change the aqueous nature of the composition of the invention.

Preferably, the composition of the invention contains water in amounts of from 60 to 99.95% by weight, more preferably 70 to 99.9% by weight, even more preferably 80 to 99.9% by weight and, most preferably, 90 to 99.9% by weight, the weight percentages being based on the complete weight of the composition of the invention.

The composition of the invention contains as the first essential ingredient or component at least one, preferably one, water-soluble or water-dispersible compound selected from the group consisting of N-substituted diazenium dioxides (A) and N′-hydroxy-diazenium oxide salts (A).

“Water-soluble” means that the relevant compounds (A) are distributed in the aqueous medium on the molecular level, whereas “water-dispersible” means that they can be finely dispersed in the aqueous medium and form a stable suspension or emulsion, preferably a stable suspension. Most preferably, the compounds (A) are water-soluble.

Preferably, the N-substituted diazenium dioxides (A) are of the general formula I:

R[—N⁺(—O)═N—OH]ₙ (I).

In the general formula I, the variable R designates a moiety containing or consisting of at least one residue selected from the group consisting of monomeric, oligomeric and polymeric, substituted and unsubstituted, saturated and unsaturated aliphatic and cycloaliphatic groups not containing or containing at least one heteroatom and/or at least one bifunctional or trifunctional linking group, and monomeric, oligomeric and polymeric, substituted and unsubstituted aromatic groups not containing or containing at least one heteroatom.

In the general formula I, the the index n is a number of from 1 to 1000, preferably 1 to 500, more preferably 1 to 100 and, even more preferably, 1 to 50 and, most preferably, 1 to 10.

When the residue R is an oligomeric or polymeric moiety, the number n does not necessarily have to be an integer but can also be a broken number. This is due to the statistical nature of the oligomeric and polymeric moieties. When the residue R is a monomeric moiety, the number n is usually an integer.

Consequently, with regard to the diazenium dioxide group, the residue R can be monofunctional or multifunctional, which means that the residue R contains one diazenium dioxide group or more than one diazenium dioxide group.

In the case that the residue R contains at least one heteroatom and/or at least one bifunctional or trifunctional linking group, the diazenium dioxide groups are preferably bonded to a carbon atom of the residue R.

A given residue R can consist of one of the above mentioned moieties described in more detail below or such residue R can contain two or more of the above mentioned moieties described in more detail below, which groups are different from each other and may be linked to each other via at least one covalent bond and/or by one or more of the above mentioned linking groups described in more detail below.

In the context of the present invention “monomeric” means that the relevant residues R are derived from monomeric compounds R′ containing or consisting of a single characteristic structural unit or two characteristic structural units. Preferably, the monomeric compounds R′ have molecular weights in the range of from 40 to 1000 Dalton.

In the context of the present invention “oligomeric” means that the relevant residues R are derived from oligomeric compounds R′ containing or consisting of 3 to about 12 characteristic repeating structural units. Preferably, the oligomeric compounds R′ have weight average molecular weights M_{w} of from 100 to 2500 Dalton.

In the context of the present invention “polymeric” means that the relevant residues R are derived from polymeric compounds R′ containing or consisting of at least 12 characteristic repeating structural units. Preferably, the polymeric compounds R′ have weight average molecular weights M_{w} of from 500 to 2,000,000 Dalton, more preferably 1000 to 1,000,000 Dalton, and most preferably 5000 to 500,000 Dalton.

“Unsubstituted” means that—except for the heteroatoms described below—the relevant residues R only consist of carbon atoms and hydrogen atoms.

“Substituted” means that the relevant residues R contain at least one substituent which is inert, i.e., non-reactive under the conditions of the preparation, the handling, the storage and the use of the compounds (A) in the compositions of the invention.

Examples of suitable inert substituents are halogen atoms such as fluorine, chlorine and bromine, hydroxy groups, carboxylic acid groups, sulfonic acid groups, phosphinic acid groups, nitro groups, and nitrile groups, preferably fluorine and chlorine atoms and nitrile groups.

“Saturated” means that the relevant residues R do not contain any olefinically or acetylenically unsaturated groups. Consequently, “unsaturated” means that the relevant residues R contain at least one olefinically and/or acetylenically unsaturated group.

Preferably, the heteroatoms are selected from the group consisting of boron, oxygen, sulfur, nitrogen, phosphorus, and silicium, most preferably oxygen and nitrogen.

Preferably, the bifunctional and trifunctional linking groups are inert in the above-mentioned sense.

Examples for suitable bifunctional and trifunctional linking groups are carbonic acid ester, thiocarbonic acid ester, carbonate, thiocarbonate, phosphoric acid ester, thiophosphoric acid ester, phosphinic acid ester, thiophosphonic acid ester, phosphite, thiophosphonic acid ester, sulfonic acid ester, amide, amine, thioamide, phosphoric acid amide, thiophosphoric acid amide, phosphonic acid amide, thiophosphonic acid amide, sulfonic acid amide, imide, hydrazide, urethane, urea, thiourea, carbonyl, thiocarbonyl, sulfon and sulfoxide groups, most particularly, carbonate, urethane, carbonyl and carbonic acid ester groups, most particular preferably carbonic acid ester groups.

Preferably, the saturated, monomeric, aliphatic moieties R are derived from linear or branched aliphatic hydrocarbons R′, more preferably, linear or branched aliphatic hydrocarbons R′ having 1 to 20, even more preferably 1 to 16, most preferably, 1 to 12 and, most particularly preferably, 1 to 4 carbon atoms to the molecule, in particular, methane, ethane, propane, butane, isobutane, pentane, isopentane,neopentane, hexane, isohexane, heptane, octane, isooctane, nonane, decane, undecane, and dodecane, in particular methane, ethane, propane, butane and isobutane.

Preferably, the substituted, saturated, monomeric, aliphatic moieties R are derived from linear or branched aliphatic hydrocarbons R′, more preferably, linear or branched aliphatic hydrocarbons R′ having 1 to 20, even more preferably 1 to 16, most preferably, 1 to 12 and, most particularly preferably, 1 to 4 carbon atoms to the molecule, and at least one halogen atom selected from the group consisting of fluorine and chlorine.

Examples for particularly suitable substituted, saturated, monomeric, aliphatic moieties R are derived from fluoro, chloro, difluoro, dichloro, chlorofluoro, trifluoro, trichloro, difluorochloro and fluorodichloro methane; fluoro, chloro, 1,1- and 1,2-difluoro, 1,1- and 1,2-dichloro, 1-chloro-1-fluoro, 1-chloro-2-fluoro, 1-difluoro-2-fluoro, 2-trifluoro, 1-dichloro-2-chloro, 2-trichloro, 1-difluro-2-chloro, 2-difluorochloro, 1-fluoro-2-dichoro and 2-fluorodichloro ethane, fluoro, chloro, difluoro, dichloro, trifluoro, trichloro, tetrafluoro, tetrachloro, pentafluoro, pentachloro, hexafluoro, hexachloro, heptafluoro and heptachloro propane as well as the mixed fluorochloro substituted propanes, fluoro, chloro, difluoro, dichloro, trifluoro, trichloro, tetrafluoro, tetrachloro, pentafluoro, pentachloro, hexafluoro, hexachloro, heptafluoro, heptachloro, octafluoro, octachloro, nonafluoro and nonachloro butane and isobutane as well as the mixed fluorochloro substituted butanes and isobutanes.

Preferably, the unsubstituted, saturated, monomeric, aliphatic moieties R having at least one heteroatom are derived from linear or branched aliphatic hydrocarbons R′ more preferably, linear or branched aliphatic hydrocarbons R′ having 2 to 20, even more preferably 2 to 16, most preferably, 2 to 12 and, most particularly preferably, 2 to 6 carbon atoms to the molecule, and at least one nitrogen atom and/or oxygen atom between 2 carbon atoms.

Examples for particularly suitable unsubstituted, saturated, monomeric, aliphatic moieties R having at least one heteroatom are derived from dimethyl ether, methylether ether, diethyl ether, 2,4-dioxapentane, 2,4-oxahexane, 3,6-dioxaoctane, dimethyl amine, trimethyl amine, diethyl amine, triethylamine, dipropylamine, and 2-oxa-4-aza-pentane.

Preferably, the substituted, saturated, monomeric, aliphatic moieties R having at least one heteroatom are derived from linear or branched aliphatic hydrocarbons R′, more preferably, linear or branched aliphatic hydrocarbons R′ having 2 to 20, even more preferably 2 to 16, most preferably, 2 to 12 and, most particularly preferably, 2 to 6 carbon atoms to the molecule, at least one nitrogen atom and/or oxygen atom between 2 carbon atoms and at least one fluorine and/or chlorine atom.

Examples for particularly suitable substituted, saturated, monomeric, aliphatic moieties R having at least one heteroatom are derived from dimethyl ether, methylether ether, diethyl ether, 2,4-dioxapentane, 2,4-oxahexane, 3,6-dioxaoctane, dimethyl amine, trimethyl amine, diethyl amine, triethylamine, dipropylamine, and 2-oxa-4-aza-pentane which may be substituted preferably by at least one fluorine atom and/or chlorine atom and/or nitrile group.

Preferably, the substituted or unsubstituted, saturated, monomeric, aliphatic moieties R having at least one bifunctional or trifunctional linking group are derived from linear or branched aliphatic hydrocarbons R′ more preferably, linear or branched aliphatic hydrocarbons R′ having 2 to 20, even more preferably 2 to 16, most preferably, 2 to 12 and, most particularly preferably, 2 to 6 carbon atoms to the molecule and at least one bifunctional or trifunctional linking group. The relevant hydrocarbons R′ may also carry at least one substituent.

Examples for particularly suitable substituted or unsubstituted, saturated, monomeric, aliphatic moieties R are derived from acetone, methylethylketone, diethylketone, methylbutylketone, ethylbutylketone, acetylacetone, formic acid methyl, ethyl, propyl, butyl and pentyl ester, acetic acid methyl, ethyl, propyl and butyl ester, propionic acid methyl, ethyl and propyl ester, and butyric acid methyl and ethyl ester, which may be substituted preferably by at least one fluorine and/or chlorine atom.

Preferably, the substituted or unsubstituted, saturated, oligomeric or polymeric aliphatic moieties R are derived from linear, branched, hyperbranched, starshaped, dendrimeric and comblike homopolymers and copolymers of ethylene, propylene, butylene and isobutylene. The copolymers may contain minor amounts of copolymerized higher olefins like hexene and octene. The said homopolymers and copolymers may be substituted preferably by at least one fluorine and/or chlorine atom.

Preferably, the substituted or unsubstituted, saturated, oligomeric or polymeric, aliphatic moieties R containing at least one heteroatom, in particular at least one oxygen atom, are derived from linear, branched, hyperbranched, starshaped, dendrimeric and comblike homopolymers and copolymers of alkylene imines, in particular, ethylenimine, alkylene oxides, in particular, ethyleneoxide, propyleneoxide, butylene oxide and tetrahydrofurane, and vinyl ethers and esters, in particular vinyl methyl, ethyl, propyl, and butyl ether and ester. The said homopolymers and copolymers may also contain the bifunctional or trifunctional linking groups described above.

Preferably, the substituted or unsubstituted, saturated, oligomeric or polymeric, aliphatic moieties R containing at least one bifunctional or trifunctional, preferably bifunctional, linking group are derived from linear, branched, hyperbranched, starshaped, dendrimeric and comblike polycarbonates, polyurethanes, and (meth)acrylate(co)polymers, in particular polymethyl acrylate and polymethyl methacrylate PMMA. The said homopolymers and copolymers may be substituted preferably by at least one fluorine and/or chlorine atom.

Preferably, the substituted or unsubstituted, unsaturated, monomeric and oligomeric, aliphatic moieties R are derived from from customary and known olefinically or acetylenically unsaturated monomers such as olefins, acetylenes, acrylates, methacrylates, vinyl esters, vinyl esters, allyl ethers, allyl esters, and acyclic monoterpenes, sesquiterpenes, diterpenes, and triterpenes as described in Römpp Online 2010, Thieme Chemistry, www.roempp.com, “Terpene”, “Sesquiterpene”, “Diterpene”, and “Triterpene”, which monomers may be substituted preferably by at least one fluorine and/or chlorine atom and/or nitrile group.

Examples for particularly suitable substituted or unsubstituted, unsaturated, monomeric and oligomeric, aliphatic moieties R are ethylene, propylene, butylene, isoprene, acetylene, propyne, methyl and ethyl acrylate, methyl methacrylate, vinyl ethers and esters, in particular vinyl methyl, ethyl, propyl, and butyl ether and ester, and allyl methyl, ethyl, propyl, and butyl ether and ester, ocimene, myrcene, citral, alpha- and beta-jonone and pseudojonone. The said monomers may be substituted preferably by at least one fluorine and/or chlorine atom and/or nitriles group.

Preferably, the substituted or unsubstituted, saturated, cycloaliphatic moieties R are derived from saturated monocyclic, dicyclic, tricyclic, tetracyclic hydrocarbons, which may be substituted preferably by at least one fluorine and/or chlorine atom and/or nitrile group.

Examples for particularly suitable substituted or unsubstituted, saturated, cycloaliphatic moieties R are cyclopropane, cyclobutane, cyclopentane, cyclohexane, cycloheptane, cyclooctane, cyclodecane, o-, m- and p-menthane, menthone, carane, pinane, carone, bornylchloride, isobornylchloride, campher, bornane, norbonane, 8.9.10-trinorbonane, spiro[3.3]heptane, spirobicyclohexane, decalin, hydroindane, norcamphane, bicyclo[2.2.1]octane,adamantane, twistane, and congressane which may be substituted preferably by at least one fluorine and/or chlorine atom and/or nitrile group.

Preferably, the substituted or unsubstituted, saturated, cycloaliphatic moieties R containing at least one heteroatom are derived from from saturated, monocyclic, dicyclic, tricyclic, tetracyclic hydrocarbons containing at least one heteroatom, which hydrocarbons may be substituted preferably by at least one fluorine and/or chlorine atom and/or nitrile group.

Examples for particularly suitable substituted or unsubstituted, saturated cycloaliphatic moieties R containing at least at least one heteroatom, in particular at least one nitrogen atom and/or oxygen atom are derived from tetrahydrofurane, 1,4-dioxane, gamma-butyrolactone, epsilon-caprolactame, morpholine, uretidine, isooxazolidine, pyrrolidine, imidazoline, pyrazolidine, piperidine, piperazine, and quinuclidine which may be substituted preferably by at least one fluorine and special chlorine atom and/or nitrile group.

Preferably, the substituted or unsubstituted, unsaturated cycloaliphatic moieties R are derived from unsaturated monocyclic, dicyclic, tricyclic, tetracyclic hydrocarbons, which may be substituted preferably by at least one fluorine and/or chlorine atom and/or nitrile group.

Examples for particularly suitable substituted or unsubstituted, unsaturated, cycloaliphatic moieties R are derived from cyclopropene, cyclobutene, cyclopentene, cyclopentadiene, cyclohexa-1,3- and -1,2-diene, cycloheptene, cyclooctene, cyclodecene, alpha- and gamma-terpinene, terpinolene, alpha- and beta-phellandrene, limonene, dipentene, pullegone, carvone, carvenone, alpha- and beta-pinene, bisabolene cadinene, beta-selinene, camphorene, and spiro[4.5]deca-1,6-diene which may be substituted preferably by at least one fluorine and/or chlorine atom and/or nitrile group.

Preferably, the substituted or unsubstituted, saturated, cycloaliphatic moieties R containing at least one heteroatom are derived from from unsaturated, monocyclic, dicyclic, tricyclic, tetracyclic hydrocarbons containing at least one heteroatom, which hydrocarbons may be substituted preferably by at least one fluorine and/or chlorine atom and/or nitrile group.

Examples for particularly suitable substituted or unsubstituted, unsaturated cycloaliphatic moieties R containing at least at least one heteroatom, in particular at least one nitrogen atom and/or oxygen atom are derived from 2H-pyrane, 2H-pyrrole, delta²-pyrroline, delta²-imidazoline, delta³-pyrazole, pyrrolenine, and delta⁴-isoxazonine which hydrocarbons may be substituted preferably by at least one fluorine and/or chlorine atom and/or nitrile group.

Preferably, the substituted and unsubstituted, monomeric, aromatic moieties R are derived from monocyclic and polycyclic, aromatic compounds, in particular, benzene, biphenyl, terphenyl, diphenylether, diphenylamine, diphenylketone, diphenylsulfide, diphenylsulfoxide, diphenylsulfone, naphthalene, indane, fluorane, fluorenone, anthracene, and phenanthrene, which hydrocarbons may be substituted preferably by at least one fluorine and/or chlorine atom and/or nitrile group.

Preferably, the substituted and unsubstituted, oligomeric and polymeric, aromatic moieties R are derived from aromatic groups containing oligomers and polymers, in particular, polyesters, particularly, poly(ethyleneterephthalate) PET and poly(butyleneterephthalate) PBT, polyethers, in particular, poly(phenyleneoxides) such as poly(2,6-dimethylphenyleneoxide), and homopolymers and copolymers of styrene, which oligomers and polymers may be substituted preferably by at least one fluorine and/or chlorine atom and/or nitrile group.

Preferably, the substituted and unsubstituted, monomeric, aromatic moieties R containing at least one heteroatom are derived from monocyclic and polycyclic heteroaromatic compounds, in particular oxygen, sulfur and/or nitrogen-containing heteroaromatic compounds, which may be substituted preferably by at least one fluorine and/or chlorine atom and/or nitrile group.

Examples of particularly suitable substituted and unsubstituted, monomeric, aromatic moieties R containing at least one heteroatom are derived from furane, thiophene, pyrrole, imidazole, pyrazole, isothiazole, isooxazole, triazoles, pyridine, pyrazine, pyrimidine, pyridazine, benzothiophene, thianthrene, isobenzofurane, phenoxathiine, indolizine, isoindole, indole, purine, isoquinoline, quinoline, phthalazine, 1,8-naphthyridine, quinoxaline, quinazoline, cinnoline, pteridine, carbazole, acridine, and phenanthridine, which may be substituted preferably by at least one fluorine and/or chlorine atom and/or nitrile group.

As already explained above, the above described moieties R can be combined with each other in any way to form the variable R of the general formula I. Thus, by way of example, a moiety R derived from benzene can be combined with a moiety R derived from a copolymer of ethyleneoxide via an ether group in order to render the N-substituted diazenium dioxide (A) more water-soluble.

More preferably, the moieties R are derived from monomeric, saturated, aliphatic and cycloaliphatic and monomeric aromatic compounds, even more preferably from unsubstituted, monomeric, saturated, aliphatic and cycloaliphatic and unsubstituted, monomeric aromatic compounds, in particular methane, ethane, propane, butane, cyclopentane, cyclohexane, and benzene.

Most particularly preferably, the N-substituted diazenium dioxide (A) are selected from the group consisting of N-methyl-, N-ethyl-, N-propyl-, N-butyl, N-cyclohexyl-, and N-phenyl-diazenium dioxide.

Preferably, the N-substituted N′-hydroxy-diazenium oxide salts (A) are of the general formula II:

{R[—N(—O)—N—O]⁻ₙ}ₘ (M^{m+})ₙ (II),

wherein the variable R has the above-mentioned meaning and the indices n and m are both numbers of from 1 to 1000, preferably 1 to 500, more preferably 1 to 100 and, even more preferably, 1 to 50 and, most preferably, 1 to 10.

When the residue R is an oligomeric or polymeric moiety, the numbers n and m does not necessarily have to be integers but can also be broken numbers. This is due to the statistical nature of the oligomeric and polymeric moieties. When the residue R is a monomeric moiety, the numbers n and m are usually integers.

The variable M designates a cation which is selected from the group consisting of organic and inorganic, monomeric, oligomeric and polymeric cations.

Examples for suitable monomeric organic cations are primary, secondary, tertiary and quaternary ammonium cations, primary, secondary and tertiary phosphonium cations, and primary and secondary sulfonium cations, in particular, the tetramethylammonium cation.

Examples for suitable oligomeric and polymeric cations are oligomers and polymers containing primary, secondary, tertiary and quaternary ammonium cations, primary, secondary and tertiary phosphonium cations, and primary and secondary sulfonium cations, in particular, cationic polyethyleneimines.

Examples for suitable inorganic cations are the cations of ammonia, lithium, sodium, potassium, rubidium, cesium, magnesium, calcium, strontium, barium, aluminum, gallium, indium, germanium, tin, lead, antimony, bismuth, scandium, yttrium, lanthanum, the rare earth metals, titanium, zirconium, hafnium, vanadium, niobium, tantalum, chromium, molybdenum, tungsten, manganese, rhenium, iron, ruthenium, osmium, cobalt, rhodium, iridium, nickel, palladium, platinum, copper, silver, gold, zinc, and cadmium, preferably the cations of ammonia, lithium, sodium and potassium.

Most particularly preferably, the N′-hydroxy-diazenium dioxide salts (A) are selected from the group consisting of N-methyl-, N-ethyl-, N-propyl-, N-butyl, N-cyclohexyl-, and N-phenyl-N′-hydroxy-diazenium dioxide ammonium, lithium, sodium and potassium salt.

The concentration of the N-substituted diazenium dioxides (A) and/or N′-hydroxy-diazenium oxide salts (A) in the composition of the invention can vary broadly and, therefore, can be most advantageously adjusted to a particular composition, process and use of the invention. Preferably, the composition of the invention contains, based on its complete weight, 0.01 to 1000 ppm, more preferably 0.05 to 750 ppm, even more preferably 0.075 to 500 ppm and, most preferably 0.1 to 500 ppm of the compound (A).

The second essential ingredient of the composition of the invention is at least one type of abrasive particles (B).

In principle, any natural or synthetic abrasive particulate material customarily used in the field of polishing, in particular, chemical mechanical polishing or planarization (CMP), can be used as the ingredient (B). Preferably, the abrasive particles (B) are selected from the group consisting of alumina, silica, silicon nitride, silicon carbide, titania, zirconia, ceria, zinc oxide, and mixtures thereof.

The average particle size of the abrasive particles (B) can vary broadly and, therefore, can be adjusted most advantageously to the particular requirements of a composition, process and use of the invention. Preferably, the average particle size as determined by dynamic laser light scattering is in the range of from 1 to 2000 nm, preferably 1 to 1000 nm, more preferably 1 to 750, and, most preferably, 1 to 500 nm.

Most preferably, the abrasive particles (B) contain or consist of ceria.

The abrasive particles (B) which contain ceria can contain minor amounts of other rare earth metal oxides.

Preferably, the abrasive particles (B) which contain ceria are composite particles (B) comprising a core containing or consisting of at least one other abrasive particulate material which is different from ceria, in particular alumina, silica titania, zirconia, zinc oxide, and mixtures thereof.

Such composite particles (B) are known, for example, from WO 2005/035688 A1, U.S. Pat. No. 6,110,396, U.S. Pat. No. 6,238,469 B1, U.S. Pat. No. 6,645,265 B1, K. S. Choi et al., Mat. Res. Soc. Symp. Proc. Vol. 671, 2001 Materials Research Society, M5.8.1 to M5.8.10, S.-H. Lee et al., J. Mater. Res., Vol. 17, No. 10, (2002), pages 2744 to 2749, A. Jindal et al., Journal of the Electrochemical Society, 150 (5) G314-G318 (2003), Z. Lu, Journal of Materials Research, Vol. 18, No. 10, October 2003, Materials Research Society, or S. Hedge et al., Electrochemical and Solid-State Letters, 7 (12) G316-G318 (2004).

Most preferably, the composite particles (B) are raspberry-type coated particles comprising a core selected from the group consisting of alumina, silica titania, zirconia, zinc oxide, and mixtures thereof with a core size of from 20 to 100 nm wherein the core is coated with ceria particles having a particle size below 10 nm.

The amount of the abrasive particles (B) used in the composition of the invention can vary broadly and, therefore can be adjusted most advantageously to the particular requirements of a composition, a process and use of the invention. Preferably, the composition of the invention contains 0.005 to 10% by weight, more preferably 0.01 to 8% by weight and, most preferably 0.01 to 6% by weight of the abrasive particles (B), the weight percentages being based on the complete weight of the composition of the invention.

The composition of the invention can contain at least one functional component (C) which is different from the ingredients or components (A) and (B).

Preferably, the functional component (C) is selected from the group of compounds customarily used ceria-based CMP slurries. Examples of such compounds (C) are described at the outset and are disclosed, for example, by Y. N. Prasad et al. in Electrochemical and Solid-State Letters, 9 (12) G337-G339 (2006), Hyun-Goo Kang et al. in Journal of Material Research, volume 22, No. 3, 2007, pages 777 to 787, S. Kim et al. in Journal of Colloid and Interface Science, 319 (2008), pages 48 to 52, S. V. Babu et al. in Electrochemical and Solid-State Letters, 7 (12) G327-G330 (2004), Jae-Dong Lee et al. in Journal of the Electrochemical Society, 149 (8) G477-G481, 2002, the U.S. Pat. No. 5,738,800, U.S. Pat. No. 6,042,741, U.S. Pat. No. 6,132,637, U.S. Pat. No. 6,218,305 B, U.S. Pat. No. 5,759,917, U.S. Pat. No. 6,689,692 B1, U.S. Pat. No. 6,984,588 B2, U.S. Pat. No. 6,299,659 B1, U.S. Pat. No. 6,626,968 B2, U.S. Pat. No. 6,436,835, B1 U.S. Pat. No. 6,491,843 B1, U.S. Pat. No. 6,544,892 B2, U.S. Pat. No. 6,627,107 B2, U.S. Pat. No. 6,616,514 B1, and U.S. Pat. No. 7,071,105 B2, the American patent applications US 2002/0034875 A1, US 2006/0144824 A1, US 2006/0207188 A1, US 2006/0216935 A1, US 2007/0077865 A1, US 2007/0175104 A1, US 2007/0191244 A1 and US 2007/0218811 A1, and the Japanese patent application JP 2005-336400 A.

Moreover, the functional component (C) is selected from the group consisting of organic, inorganic and hybrid organic-inorganic abrasive particles being different from the particles (B), materials having a lower critical solution temperature LOST or an upper critical solution temperature UCST, oxidizing agents, passivating agents, charge reversal agents, organic polyols having at least 3 hydroxide groups that are not dissociable in the aqueous medium, oligomers and polymers formed from at least one monomer having at least 3 hydroxide groups that are not dissociable in the aqueous medium, complexing or chelating agents, frictive agents, stabilizing agents, rheology agents, surfactants, metal cations and organic solvents.

Suitable organic abrasive particles (C) and their effective amounts are known, for example, from the American patent application US 2008/0254628 A1, page 4, paragraph or from the international application WO 2005/014753 A1, wherein solid particles consisting of melamine and melamine derivatives such as acetoguanamine, benzoguanamine and dicyandiamide are disclosed.

Suitable inorganic abrasive particles (C) and their effective amounts are known, for example, from the international patent application WO 2005/014753 A1, page 12, lines 1 to 8 or the U.S. Pat. No. 6,068,787, column 6, line 41 to column 7, line 65.

Suitable hybrid organic-inorganic abrasive particles (C) and their effective amounts are known, for example, from the American patent applications US 2008/0254628 A1, page 4, paragraph [0054] or US 2009/0013609 A1, page 3, paragraph [0047] to page 6, paragraph [0087].

Suitable oxidizing agents (C) and their effective amounts are known, for example, from the European patent application EP 1 036 836 A1, page 8, paragraphs [0074] and [0075] or from the U.S. Pat. No. 6,068,787, column 4, line 40 to column 7, line 45 or U.S. Pat. No. 7,300,601 B2, column 4, lines 18 to 34. Preferably, organic and inorganic peroxides, more preferably inorganic peroxides, are used. In particular, hydrogen peroxide is used.

Suitable passivating agents (C) and their effective amounts are known, for example, from the U.S. Pat. No. 7,300,601 B2, column 3, line 59 to column 4, line 9 or from the American patent application US 2008/0254628 A1, the paragraph [0058] bridging the pages 4 and 5.

Suitable complexing or chelating agents (C), which are sometimes also designated as frictive agents (cf. the American patent application US 2008/0254628 A1, page 5, paragraph [0061]) or etching agents or etchants (cf. the American patent application US 2008/0254628 A1, page 4, paragraph [0054]), and their effective amounts are known, for example, from the U.S. Pat. No. 7,300,601 B2, column 4, lines with 35 to 48. The amino acids, in particular glycine, and, moreover, dicyandiamide and triazines containing at least one, preferably two and, more preferably, three primary amino groups such as melamine and water-soluble guanamines, particularly melamine, formoguanamine, acetoguanamine and 2,4-diamino-6-ethyl-1,3,5-triazine, are most particularly preferably used.

Suitable stabilizing agents (C) and their effective amounts are known, for example, from the U.S. Pat. No. 6,068,787, column 8, lines 4 to 56.

Suitable rheology agents (C) and their effective amounts are known, for example, from the American patent application US 2008/0254628 A1, page 5, paragraph [0065] to page 6, paragraph [0069].

Suitable surfactants (C) and their effective amounts are known, for example, from the international patent application WO 2005/014753 A1, page 8, line 23, to page 10, line 17 or from the U.S. Pat. No. 7,300,601 B2, column 5, line 4 to column 6, line 8.

Suitable polyvalent metal ions (C) and their effective amounts are known, for example, from the European patent application EP 1 036 836 A1, page 8, paragraph [0076] to page 9, paragraph [0078].

Suitable organic solvents (C) and their effective amounts are known, for example, from the U.S. Pat. No. 7,361,603 B2, column 7, lines 32 to 48 or the American patent application US 2008/0254628 A1, page 5, paragraph [0059].

Suitable materials (C) exhibiting a lower critical solution temperature LOST or an upper critical solution temperature UCST are described, for example, in the article of H. Mori, H. Iwaya, A. Nagai and T. Endo, Controlled synthesis of thermoresponsive polymers derived from L-proline via RAFT polymerization, in Chemical Communication, 2005, 4872-4874; or in the article of D. Schmaljohann, Thermo- and pH-responsive polymers and drug delivery, Advanced Drug Delivery Reviews, volume 58 (2006), 1655-1670 or in the American patent applications US 2002/0198328 A1, US 2004/0209095 A1, US 2004/0217009 A1, US 2006/0141254 A1, US 2007/0029198 A1, US 2007/0289875 A1, US 2008/0249210 A1, US 2008/0050435 A1 or US 2009/0013609 A1, the U.S. Pat. No. 5,057,560, U.S. Pat. No. 5,788,82 and U.S. Pat. No. 6,682,642 B2, the international patent applications WO 01/60926 A1, WO2004/029160 A1, WO 2004/0521946 A1, WO 2006/093242 A2 or WO 2007/012763 A1, in the European patent applications EP 0 583 814 A1, EP 1 197 587 B1 and EP 1 942 179 A1, or the German patent application DE 26 10 705; or they are sold under the trademarks Pluronic™, Tetronic™ and Basensol™ by BASF Corporation and BASF SE as evidenced by the company brochure of BASF Corporation “Pluronic™ & Tetronic™ Block Copolymer Surfactants, 1996” or the American patent US 2006/0213780 A1.

In a first advantageous and preferred embodiment, the composition of the invention contains at least one charge reversal agent (C).

In principle, any known charge reversal agent (C) customarily used in the field of CMP can be used. Preferably, the charge reversal agent (C) is selected from the group consisting of monomeric, oligomeric and polymeric compounds containing at least one anionic group selected from the group consisting of carboxylate, sulfinate, sulfate, phosphonate and phosphate groups. Examples of particularly suitable charge reversal agents (C) are described, for example, in the U.S. Pat. No. 7,2065,055 B2, column 4, lines 24 to 45 or in the Japanese patent application JP 2005-336400 A (cf. the claims 1 to 6).

The concentration of the charge reversal agent (C) in the composition of the invention can vary broadly and, therefore, can be adjusted most advantageously to the particular requirements of a given composition, process and use of the invention. Preferably, the the charge reversal agent (C) is used in amounts so that a weight ratio of ceria to charge reversal agent (C) of 10 to 2000 and, more preferably, 20 to 1000 results.

In a second advantageous and preferred embodiment, the composition of the invention contains at least one organic polyol (C) and, more preferably, at least two organic polyols (C) having at least 3 hydroxide groups that are not dissociable in the aqueous medium and/or oligomers and polymers formed from at least one monomer having at least 3 hydroxide groups that are not dissociable in the aqueous medium.

More preferably, the organic polyol or polyols (C) is or are selected from the group consisting of monosaccharides, disaccharides, oligosaccharides, polysaccharides, desoxy sugars, amino sugars, aldonic acids, ketoaldonic acids, uronic acids, aldaric acids, sugar alcohols, and cyclitols, even more preferably, monosaccharides and cyclitols, and, particularly preferably, galactose and myo-, scyllo-, muco-, chiro-, neo-, allo-, epi- and cis-inositol. Most preferably, galactose and myo-inositol are used as the organic polyols (C).

The concentration of the organic polyols (C) in the composition of the invention can vary broadly, and, therefore can be adjusted most advantageously to the particular requirements of the composition, process and use of the invention. Preferably, the composition of the invention contains the organic polyols (C) in amounts of from 0.001 to 5% by weight, more preferably 0.005 to 4% by weight, even more preferably 0.01 to 2% by weight and, most preferably 0.01 to 1% by weight, the weight percentages being based on a complete weight of the composition of the invention.

In a third most advantageous and most preferred embodiment, the composition of the invention contains the above described charge reversal agents (C) and organic polyols (C).

If present, the functional component (C) can be contained in varying amounts. Preferably, the total amount of (C) is not more than 10 wt. % (“wt. %” means “percent by weight”), more preferably not more than 2 wt. %, most preferably not more than 0.5 wt. %, particularly not more than 0.1 wt. %, for example not more than 0.01 wt. %, based on the total weight of the corresponding CMP composition. Preferably, the total amount of (C) is at least 0.0001 wt. %, more preferably at least 0.001 wt. %, most preferably at least 0.008 wt. %, particularly at least 0.05 wt. %, for example at least 0.3 wt. %, based on the total weight of the corresponding composition.

The composition of the invention can optionally contain at least one pH-adjusting agent or buffering agent (D) which is materially different from the ingredients (A) and (B).

Suitable pH-adjusting agents or buffering agents (D) and their effective amounts are known, for example, from the European patent application EP 1 036 836 A1, page 8, paragraphs [0080], [0085] and [0086], the international patent application WO 2005/014753 A1, page 12, lines 19 to 24, the American patent application US 2008/0254628 A1, page 6, paragraph [0073] or the U.S. Pat. No. 7,300,601 B2, column 5, lines 33 to 63. Examples for pH-adjusting agents or buffering agents (D) are potassium hydroxide, ammonium hydroxide, tetramethylammonium hydroxide (TMAH), nitric acid, and sulfuric acid.

If present, the pH-adjusting agent or buffering agent (D) can be contained in varying amounts. Preferably, the total amount of (D) is not more than 20 wt. %, more preferably not more than 7 wt. %, most preferably not more than 2 wt. %, particularly not more than 0.5 wt. %, for example not more than 0.1 wt. %, based on the total weight of the corresponding CMP composition. Preferably, the total amount of (D) is at least 0.001 wt. %, more preferably at least 0.01 wt. %, most preferably at least 0.05 wt. %, particularly at least 0.1 wt. %, for example at least 0.5 wt. %, based on the total weight of the corresponding composition.

Preferably, the pH of the composition of the invention is set between 3 and 10, more preferably, 4 and 8, even more preferably between 4 and 7, and, most preferably between 5 and 7 preferably using the aforementioned pH-adjusting agents (D).

The preparation of the composition of the invention does not exhibit any particularities but can be carried out by dissolving or dispersing the above-described ingredients (A) and (B) and optionally (C) and/or (D) in an aqueous medium, in particular, de-ionized water. For this purpose, the customary and standard mixing processes and mixing apparatuses such as agitated vessels, in-line dissolvers, high shear impellers, ultrasonic mixers, homogenizer nozzles or counterflow mixers, can be used. Preferably, the composition of the invention thus obtained can be filtered through filters of the appropriate mesh aperture, in order to remove coarse-grained particles such as the agglomerates or aggregates of the solid, finely dispersed abrasive particles (B).

Most surprisingly, the N-substituted diazenium dioxides and N′-hydroxy-diazenium oxide salts (A) are most excellently suited for the use of the invention, i.e., for manufacturing mechanical, electrical and optical devices.

Particularly, the electrical devices are integrated circuit devices, liquid crystal panels, organic electroluminescent panels, printed circuit boards, micro machines, DNA chips, micro plants and magnetic heads; the mechanical devices are high precision mechanical devices; and the optical devices are optical glasses such as photo-masks, lenses and prisms, inorganic electro-conductive films such as indium tin oxide (ITO), optical integrated circuits, optical switching elements, optical waveguides, optical monocrystals such as the end faces of optical fibers and scintillators, solid laser monocrystals, sapphire substrates for blue laser LEDs, semiconductor monocrystals, and glass substrates for magnetic disks.

More preferably, the N-substituted diazenium dioxides and N′-hydroxy-diazenium oxide salts (A) and the compositions of the inventions they are contained in are used for the manufacture of integrated circuit devices containing, in particular, integrated circuits with large-scale integration or very-large-scale integration, having structures with dimensions below 50 nm.

Most preferably, the compositions of the inventions are excellently suited for the process of the invention.

In the process of the invention, a substrate material for electrical, mechanical and optical devices, in particular, electrical devices, most preferably, integrated circuit devices, is contacted at least once with a composition of the invention and polished, in particular, chemically and mechanically polished, until the desired planarity is achieved.

The process on the invention exhibits its particular advantages in the CMP of silicon semiconductor wafers having isolating layers consisting of low-k or ultra-low-k materials and silicon nitride layers and/or polysilicon layers.

Suitable low-k or ultra-low-k materials and suitable methods of preparing the insulating dielectric layers are described in, for example, the American patent applications US 2005/0176259 A1, page 2, paragraphs [0025] to [0027], US 2005/0014667 A1, page 1, paragraph [0003], US 2005/0266683 A1, page 1, paragraph [0003] and page 2, paragraph or US 2008/0280452 A1, paragraphs [0024] to [0026] or in the U.S. Pat. No. 7,250,391 B2, column 1, lines 49 to 54 or in the European patent application EP 1 306 415 A2, page 4, paragraph [0031].

The process of the invention is particularly suited for the shallow trench isolation (STI) which requires the selective removal of silicon dioxide to silicon nitride on a patterned wafer substrate. In this process, etched trenches are overfilled with the dielectric material, e.g., silicon dioxide, which is polished using the silicon nitride barrier film as the stopping layer. In this preferred embodiment, the process of the invention ends with clearing the silicon dioxide from the barrier film while minimizing the removal of exposed silicon nitride and trench silicon oxide.

The process of the invention exhibits no particularities but can be carried out with the processes and the equipment customarily used for the CMP in the fabrication of semiconductor wafers with ICs.

As is known in the art, a typical equipment for the CMP consists of a rotating platen which is covered with a polishing pad. The wafer is mounted on a carrier or chuck with its upper side down facing the polishing pad. The carrier secures the wafer in the horizontal position. This particular arrangement of polishing and holding device is also known as the hard-platen design. The carrier may retain a carrier pad which lies between the retaining surface of the carrier and the surface of the wafer which is not being polished. This pad can operate as a cushion for the wafer.

Below the carrier, the larger diameter platen is also generally horizontally positioned and presents a surface parallel to that of the wafer to be polished. Its polishing pad contacts the wafer surface during the planarization process. During the CMP process of the invention, the composition of the invention is applied onto the polishing pad as a continuous stream or in dropwise fashion.

Both the carrier and the platen are caused to rotate around their respective shafts extending perpendicular from the carrier and the platen. The rotating carrier shaft may remain fixed in position relative to the rotating platen or may oscillate horizontally relative to the platen. The direction of rotation of the carrier typically, though not necessarily, is the same as that of the platen. The speeds of rotation for the carrier and the platen are generally, though not necessarily, set at different values.

Customarily, the temperature of the platen is set at temperatures between 10 and 70° C.

For further details reference is made to the international patent application WO 2004/063301 A1, in particular page 16, paragraph [0036] to page 18, paragraph [0040] in conjunction with the FIG. 1.

By way of the process of the invention semiconductor wafers with ICs comprising patterned low-k and ultra-low-k material layers, in particular silicon dioxide layers, having an excellent planarity can be obtained. Therefore, copper damascene patterns can be obtained which also have an excellent planarity and, in the finished, IC an excellent electrical functionality.

### EXAMPLES

### The Preparation of the Compositions 1 to 3 (Examples 1 to 3) Containing N-Cyclohexyl-N′-Hydroxy-Diazenium Dioxide Potassium Salt and of the Compositions C1 and C2 (Comparative Experiments C1 and C2)

For the examples 1 to 3 and the comparative experiments C1 and C2, the compositions 1 to 3 and Cl and C2 were prepared by dissolving and dispersing the ingredients in ultra-pure deionized water. The Table 1 shows the the amounts of the ingredients used.

TABLE 1
The Amounts of the Ingredients Used for the Preparation of the
Compositions 1 to 3 and C1 and C2

| | | | | | Myo- | |
|---|---|---|---|---|---|---|
| Comparative | Ceria | | | | Inositol | |
| Experiment/ | (percent | Charge | | Galactose | (percent | |
| Example | by | Reversal | CHDDP^{b)} | (percent | by | |
| No. | weight) | Agent | (ppm) | by weight) | weight) | pH |
| C1 | 0.1 | PP^{a)} | — | — | — | 6.6 |
| C2 | 0.1 | PP^{a)} | — | 0.05 | — | 6.6 |
| 1 | 0.1 | PP^{a)} | 12.5 | — | — | 6.6 |
| 2 | 0.1 | PP^{a)} | 12.5 | 0.05 | — | 6.6 |
| 3 | 0.1 | PP^{a)} | 12.5 | 0.05 | 0.25 | 6.6 |

^{a)}Polyphosphate; weight ratio ceria to polyphosphate = 200;
^{b)}N-Cyclohexyl-N′-hydroxy-diazenium dioxide potassium salt

### Examples 4 to 6 and Comparative Experiments C3 and C4

The Silicon Oxide over Silicon Nitride Selectivity of Compositions Containing N-Cyclohexyl-N′-Hydroxy-Diazenium Dioxide Potassium Salt (Examples 4 to 6) and of Compositions Not Containing the Salt (Comparative Experiments C3 and C4)

The composition 1 of the example 1 was used for the example 4, the composition 2 of the example 2 was used for the example 5, and the composition 3 of the example 3 was used for the example 6.

The composition C1 of the comparative experiment C1 was used for the comparative experiment C3, and the composition C2 of the comparative experiment C2 was used for that comparative experiment C4.

For determining the silicon oxide over silicon nitride selectivity, silicon wafers containing oxide layers or silicon nitride layers were used in the examples 4 to 6 and the comparative experiments C3 and C4.

The polishing rates (i.e., the material removal rate, MRR) were determined by difference of weight. In this regard, 1.9 kg/L was used as density of thermal silicon dioxide and 3.44 kg/L was used as density of silicon nitride for calculating the MRRs of the wafers before and after the CMP by a Sartorius LA310 S scale or a Filmmetrics F50 reflectometer. The polishing experiments were carried out with a Strasbaugh nSpire (Model 6EC), ViPRR floating retaining ring Carrier with the following parameters:
Down pressure: 3.5 psi (240 mbar);
back side pressure: 0.5 psi (34.5 mbar);
retaining ring pressure: 2.5 psi (172 mbar);
polishing table/carrier speed: 95/85 rpm;
slurry flow rate: 200 ml/min;
polishing time: 60 s;
pad conditioning: in situ (9.2-9.0 lbs, 41 N);
polishing pad: IC1000 A2 stacked pad, xy k grooved (R&H);
backing film: Strasbaugh, DF200 (136 holes);
conditioning disk: Strasbaugh sasol.

That Table 2 gives an overview over the obtained MRRs and calculated silicon oxide over silicon nitride selectivities.

TABLE 2
Material Removal Rates and Silicon Oxide over Silicon Nitride
Selectivities of the Compositions 1 to 3 (Examples 4 to 6)
and C1 and C2 (Comparative Experiments C3 and C4)

| Comparative | | | Selectivity |
|---|---|---|---|
| Experiment/ | MRR^{a)} | MRR^{a)} | SiO₂/ |
| Example No. | SiO₂ | Si₃N₄ | Si₃N₄ |
| C3 | 1082 | 83 | 13 |
| C4 | 940 | 15 | 61 |
| 4 | 971 | 32 | 30 |
| 5 | 1033 | 8 | 124 |
| 6 | 1057^{b)} | 3 | 352^{c)} |

^{a)}material removal rate [angstrom/minute]
^{b)}MRR (material removal rate [angstrom/minute]) of TEOS (tetraethyl orthosilicate)
^{c)}selectivity TEOS/Si₃N₄

The results shown in Table 2 makes apparent that the silicon oxide over silicon nitride selectivity can be significantly increased by the use of a N-substituted N′-hydroxy-diazenium dioxide salt, in particular, in combination with a monosaccharide or a monosaccharide and a cyclitol.

Although the composition C2 containing no N-substituted N′-hydroxy-diazenium oxide salt but a monosaccharide exhibited a comparatively high silicon oxide over silicon nitride selectivity, the composition C2 was attacked by bacteria and fungi upon storage.

1-18. (canceled)

19. An aqueous polishing composition, comprising:
(A) at least one water-soluble or water-dispersible compound selected from the group consisting of an N-substituted diazenium dioxide and an N′-hydroxy-diazenium oxide salt; and
(B) at least one type of abrasive particles.

20. The aqueous polishing composition according to claim 19, wherein:
the N-substituted diazenium dioxide (A) is represented by formula (I):
R[—N⁺(—O⁻)═N—OH]ₙ (I); and
the N′-hydroxy-diazenium oxide salt (A) is represented by formula (II):
{R[—N(—O)—N—O]⁻ₙ}ₘ (M^{m+})ₙ (II),
wherein:
R represents at least one residue selected from the group consisting of
monomeric, oligomeric and polymeric, substituted and unsubstituted, saturated and unsaturated aliphatic and cycloaliphatic groups not containing or containing at least one heteroatom and/or at least one bifunctional or trifunctional linking group, and
monomeric, oligomeric and polymeric substituted and unsubstituted aromatic groups not containing or containing at least one heteroatom; and
M is at least one selected from the group consisting of organic and inorganic, monomeric, oligomeric and polymeric cations;
n in formula (I) represents a number from 1 to 1000;
n in formula (II) represents a number from 1 to 2000; and
m in formula (II) represents a number from 1 to 2000.

21. The aqueous polishing composition according to claim 20, wherein n in formulas (I) and (II) and m in formula (II) are integers of from 1 to 10.

22. The aqueous polishing composition according to claim 21, comprising 0.01 to 1000 ppm of the compound (A), based on a complete weight of the polishing composition.

23. The aqueous polishing composition according to claim 19, wherein the abrasive particles (B) are selected from the group consisting of alumina, silica, silicon nitride, silicon carbide, titania, zirconia, ceria, zinc oxide, and mixtures thereof.

24. The aqueous polishing composition according to claim 23, wherein the abrasive particles (B) comprise ceria.

25. The aqueous polishing composition according to claim 23, wherein the abrasive particles (B) have an average particle diameter of from 1 to 1000 nm as measured by dynamic laser light scattering.

26. The aqueous polishing composition according to claim 19, further comprising:
(C) at least one functional component (C), which is different from the components (A) and (B), and is selected from the group consisting of an organic, inorganic and hybrid organic-inorganic abrasive particle that is different from the particles (B), a material having a lower critical solution temperature LCST or an upper critical solution temperature UCST, an oxidizing agent, a passivating agent, a charge reversal agent, an organic polyol having at least 3 hydroxide groups that are not dissociable in an aqueous medium, an oligomer and/or a polymer formed from at least one monomer having at least 3 hydroxide groups that are not dissociable in anaqueous medium, a complexing or chelating agent, a frictive agent, a stabilizing agent, a rheology agent, a surfactant, a metal cation and an organic solvent.

27. The aqueous polishing composition according to claim 19, further comprising:
(C) at least one functional component (C) selected from the group consisting of monomeric, oligomeric and polymeric compounds comprising at least one anionic group selected from the group consisting of carboxylate, sulfinate, a sulfate, phosphonate and a phosphate groups, a monosaccharide, a disaccharide, an oligosaccharide, a polysaccharide, a desoxy sugar, an amino sugar, an aldonic acid, a ketoaldonic acid, a uronic acid, an aldaric acid, a sugar alcohol, and a cyclitol.

28. The aqueous polishing composition according to claim 19, further comprising:
(D) at least one pH-adjusting agent (D) or buffering agent (D) that is different from the components (A) and (B).

29. The aqueous polishing composition according to claim 19, having a pH from 3 to 10.

30. A process for polishing substrate materials, the process comprising contacting a substrate material at least once with the aqueous polishing composition of claim 19 and thereby polishing the substrate material until a desired planarity is achieved.

31. The process of claim 30, wherein the substrate material comprises at least one layer comprising at least one dielectric material.

32. The process of claim 30, which is suitable for manufacturing mechanical, electrical and optical devices.

33. The process of claim 30, which is suitable for manufacturing electrical devices, which are integrated circuit devices comprising integrated circuits with large-scale integration or very-large-scale integration, having structures with dimensions below 50 nm.

34. The aqueous polishing composition according to claim 23, wherein the abrasive particles (B) consist of ceria.

35. The process of claim 30, wherein the substrate material comprises at least one layer consisting of at least one dielectric material.
